(19) United States
(12) Patent Application Publication
(10) Pub. No.: US 2011/0157480 A1
(43) Pub. Date: Jun. 30, 2011

(54) INTEGRATION SYSTEM FOR MEDICAL INSTRUMENTS WITH REMOTE CONTROL

(76) Inventor: Douglas D. Curl, Norfolk, MA (US)

(21) Appl. No.: 12/991,245

(22) PCT Filed: May 7, 2009
(86) PCT No.: PCT/US09/43157

§ 371 Date: Mar. 10, 2011

Related U.S. Application Data
(60) Provisional application No. 61/051,331, filed on May 7, 2008.
(60) Provisional application No. 61/166,204, filed on Apr. 2, 2009.

(51) Int. Cl. H04N 5/66

(52) U.S. Cl. 348/739; 348/E05.133

(57) ABSTRACT

An integration system for medical instruments is described. In various embodiments, the integration system is useful for managing information from, and controlling, multiple medical instruments in a medical facility, as well as providing high fidelity audio communications between members of a clinical team. The system can be operated remotely in a sterile environment using gesture-based control and/or voice-recognition control. The system can record combined data—instrument data, clinical data, system date, video and audio signals—from a surgical procedure synchronously, as the data would be perceived during the procedure, in a central database. The recorded data can be retrieved and reviewed for instructional, diagnostic or analytical purposes.

### CROSS-REFERENCE TO RELATED U.S. APPLICATIONS

The present application claims priority to U.S. provisional patent application No. 61/051,331 filed on May 7, 2008, and to U.S. provisional patent application No. 61/166,204 filed on Apr. 2, 2009, both of which are incorporated herein by reference.

### FIELD OF THE INVENTION

Embodiments of the invention described herein relate to integration of electronic instrumentation, data display, data handling, audio signals and remote control for certain medical and non-medical applications.

### BACKGROUND

Certain advances in medical technology have increased the number of diagnostic medical equipment present in the operating room. As an example, in some of today's advanced operating rooms in which complex medical procedures are carried out it is not uncommon to find more than a half-dozen high-tech diagnostic instruments, each having its own control console and one or plural monitors. For example, a modern EP lab may include biplane fluoroscopy (4 monitors), multichannel recoding systems (2-3 monitors), one or plural three-dimensional mapping systems (1-2 monitors), intracardiac echocardiography (1 monitor), three-dimensional reconstruction workstations (1-2 monitors) and robotic catheter manipulation systems (2-3 monitors). The numerous types of equipment present in the operating room along with associated cabling can add to operating room clutter, occupy valuable space, and make it difficult for the attending physician or attending team to monitor and control necessary instruments as well as execute surgical tasks.

### SUMMARY

The inventive system integrates control of and data display from a plurality of medical instruments used during complex medical procedures. The system also provides for recordable audio communications among attending and remote participants in the procedure. The system is useful for managing plural types of data from, and operating, multiple medical instruments in a medical facility as well as providing high fidelity audio communications between members of a clinical team. The system further provides for marked or indexed recording of combined data—video data, instrument data, and audio signals—into a synchronized data stream to facilitate review, provide instructional footage of surgical procedures, or to be analyzed for statistical or scientific purposes.

In various embodiments, an integration system for medical instruments comprises a central processing station, a high-resolution video display in communication with the central processing station, a multi-way, high-fidelity audio communication subsystem, a memory device in communication with the central processing station, and at least one control console in communication with the central processing station. In certain embodiments, communication between the central processing station and the video display is established over an optical link, e.g., a fiber-optic link. The audio communication subsystem can provide for audio communications among members using the integration system as well as members participating in a procedure for which the integration system is used. Members can be local, e.g., within a facility in which the system is located, or remote yet in communication with the system. In various embodiments, the central processing station is adapted to receive plural types of data from plural instruments, e.g., medical instruments, in communication with the integration and to provide coordinated control of the plural instruments through at least one control module. The central processing station can be further adapted to receive audio data from the audio communication subsystem.

In various aspects, data received by the central processing station can include instrument data and a wide variety of physiological data associated with a patient, e.g., heart rate, blood pressure, blood oxygenation, temperature, electrocardiogram traces, x-ray images, fluoroscopy images, etc., and the audio signals can include verbal communications between attending team members using the integration system, or audio commands issued by a team leader. In various embodiments, the central processing station provides for the simultaneous display of images representative of a selected group of received data signals from the plurality of instruments on the high-resolution video-display. The selected group of data signals can be altered by inputs or commands from a control console or received audio signals or the central processing station. An advantageous feature of the inventive integration system is that all data handled by the central processing station can be recorded in a combined and synchronized data stream. In various embodiments, the data stream can be indexed as it is stored to facilitate subsequent retrieval and review.

In various embodiments, the integration system is controllable by input from a control console and/or received audio signals. In various aspects, the integration system is adapted to provide for control of a plurality of instruments in communication with the integration system, e.g., one or more of the instruments are controllable from a control console of the integration system. A control console and/or the central processing station can be adapted to receive and process remote-control data inputs from gesture-based apparatus, imaging apparatus, audio devices and any combination thereof. Gesture-based control can be derived from one or a combination of the following means: a hand-held motion-capture device which is moved in multiple dimensions, from imaging apparatus which captures images of an object moved in multiple dimensions, from imaging apparatus which captures images of facial expressions or hand gestures, from one or multiple sensors which sense motion of an object in multiple dimensions. In certain embodiments, a control console comprises a graphical user interface displayed on the system's high-resolution video display. In certain embodiments, the integration system provides for electronic chalkboard operation, so that a system user can annotate or mark up an image displayed on the system's video display.

The foregoing and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1 is a block diagram representative of an integration system 100 in communication with a plurality of medical instruments 130-138.

FIG. 2 is a block diagram representing an embodiment of the central processing station of the inventive integration system for medical instruments.

FIG. 3 is a block diagram representing an additional embodiment of the central processing station of the inventive integration system for medical instruments.

FIG. 4 is a block diagram representing an additional embodiment of the central processing station of the inventive integration system for medical instruments.

FIG. 5A depicts an embodiment of a computing device 500 which can be included as part of the central processing station 110.

FIG. 5B depicts an embodiment of a computing device 500 which can be included as part of the central processing station 110.

FIG. 5C depicts a computing environment within which the integration system can operate.

The features and advantages of the present invention will become more apparent from the detailed description set forth below when taken in conjunction with the drawings.

### DETAILED DESCRIPTION

### I. System Overview

An integration system for medical instruments is described in various embodiments. In certain embodiments, the integration system is useful for coordinating control of and managing information provided by a plurality of medical instruments used in complex image-guided surgical procedures. The integration system further provides for high-fidelity communications among surgical team members, and allows for the recording of plural types of data, e.g., digital data, analog data, video data, instrument status, audio data, from a plurality of instruments in use during a surgical procedure. In some embodiments, the integration system minimizes the need for keyboard, mouse or other highly interactive tactile control/interface mechanisms, and can provide an effective, efficient and sterile interface between medical staff members and clinical technology. In certain embodiments, the integration system performs self-diagnostic procedures and automated tasks which aid the attending physician or attending team. The integration system can be used in a wide variety of surgical settings, e.g., electrophysiology laboratories, catheter laboratories, image guided therapy, neurosurgery, radiology, cardiac catheterization, operating room, and the like. In certain embodiments, the integration system is adapted for use in patient rooms, bays or isolettes within emergency medicine, trauma, intensive care, critical care, neo-natal intensive care as well as OB/GYN, labor and delivery facilities. The integration system can also be used in non-surgical settings which utilize image-guided technology, e.g., investment and market monitoring, manufacturing and process plant monitoring, surveillance (e.g., at casinos), navigating a ship/airplane/space shuttle/train, and so on.

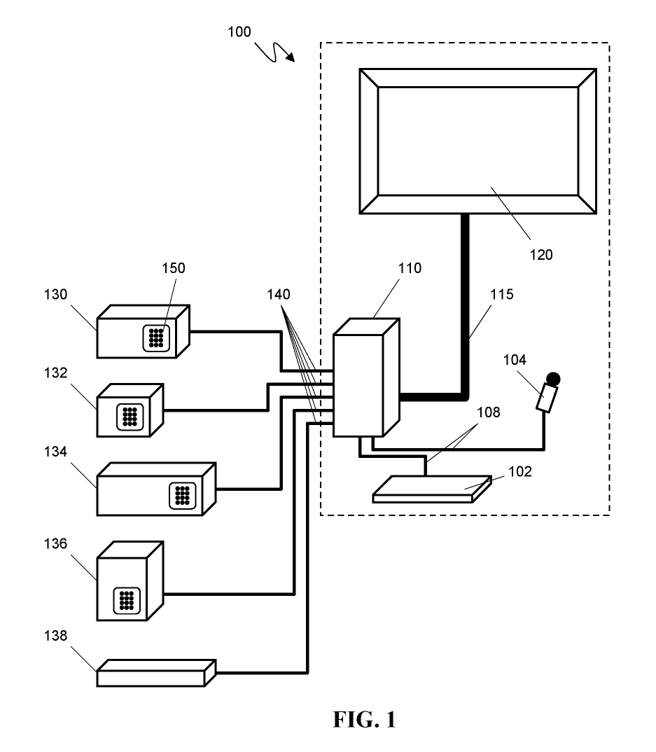

Referring now to FIG. 1, an embodiment of an integration system 100 for medical instruments is depicted in block diagram form. In overview, the inventive integration system comprises a central processing station 110 in communication with one or plural high-resolution, video-display devices 120 via communication link 115. The central processing station 110 can include and be in communication with one or plural control consoles 102, via a first communication link 108. Additionally, the central processing station can include an audio communication subsystem adapted to receive audio input from one or plural external audio devices 104 via a second communication link 108. The central processing station can further receive, and transmit, plural types of data over communication links 140 from, and to, a plurality of medical instruments 130, 132, 134, 136, 138. One or more of the plurality of medical instruments may have native controls 150, normally used to operate the instrument. The central processing station 110 can also receive audio data from the audio communication subsystem.

In various embodiments, any components of the inventive integration system 100 placed in an operating room can undergo sterilization treatment. In some embodiments, the main high-resolution video display 120 and control console 102 is coated with an FDA certified anti-bacterial powder. In some embodiments, the main high-resolution video display 120 is covered with a clear sterilized mylar film or similar material. The use of a film can allow a team member to draw visual aids on the display, e.g., an intended destination for a catheter, without permanently marking the monitor. An additional advantage of using a film is its easy disposal after a procedure.

In various embodiments, communication link 115 is a fiber optic link or an optical link, and data transmitted over link 115 is substantially unaffected by magnetic fields having a field strengths between about 0.5 Tesla (T) and about 7 T, between about 1 T and about 7 T, between about 2 T and about 7 T, and yet between about 4 T and about 7 T. In certain embodiments, high magnetic fields substantially do not affect timing sequences of data transmitted over link 115. In some embodiments, communication link 115 comprises an ultrasonic, infrared, or radio-frequency (RF) communication link. In some embodiments, the communication links 140, 108 are wired, whereas in some embodiments, the communication links are wireless, e.g., infrared, ultrasonic, optical, or radio-frequency communication links. In some embodiments, the communication links 140, 108 are fiber optic or optical links. Transmission of data which is substantially unaffected by high magnetic fields is advantageous when the integration system is used in a facility having a nuclear magnetic resonance (NMR) imaging apparatus or any apparatus producing high magnetic fields. In certain embodiments, the optical link comprises a DVI cable, e.g., a DVI-D fiber optic cable available from DVI Gear, Inc. of Marietta, Ga.

### II. System Operation and Control

As an overview of system operation, the central processing station 110 coordinates operation of the inventive integration system 100. Operation of the integration system 100 comprises control of data and images displayed on the video display 120, control of one or more of the plurality of instruments 130, 132, 134, 136, 138 in communication with the integration system, control of software in operation on the integration system, and control of the recordation of any data handled by the integration system. Software and/or firmware can execute on a central processing unit within the central processing station to assist in overall system operation. The integration system 100 can be controlled by a user operating a control console 102 and/or by voice commands input through an audio device 104. In various aspects, the system 100 has voice-recognition software which recognizes voice input and translates voice commands to machine commands recognizable by an instrument or the central processing station 110. In various aspects, the integration system is adapted to provide coordinated control of the plurality of instruments through at least one control console of the integration system.

The term “control console” is a general term which encompasses any apparatus providing control or command data to the integration system. A control console 102 can comprise a keyboard, a mouse controller, a touchpad controller, manual knobs, manual switches, remote-control apparatus, imaging apparatus adapted to provide control data, audio apparatus, infrared sources and sensors, or any combination thereof. In some embodiments, the control console 102 and software in operation on the integration system provide for “electronic chalkboard” operation, as described below. In some embodiments, a control console 102 comprises a graphical user interface (GUI), which is displayed on all or a portion of the video display 120 or on an auxiliary display 205. In certain embodiments, the GUI is displayed temporarily during operation of the integration system to provide for the inputting of commands to control the integration system.

In various aspects, a user can select one or plural data streams received from the plurality of medical instruments 130, 132, 134, 136, 138 for display on a high-resolution, video-display device 120. The selection of the one or plural data streams can be done in real time by entering commands at a control console 102, or according to preset display configurations. Additionally, in various aspects, a user can operate one or more of the plurality of medical instruments 130, 132, 134, 136, 138 via a control console 102. In various embodiments, the integration system 100 provides for the recording of video data, instrument data, and audio data handled by the system during a procedure.

The effective integration of clinical, video and audio information requires that a physician or other operator have the ability to manipulate such data as to specifically control and prioritize which image or images are viewed, with immediate and customizable control over image selection, layout, location and size and timing. In various embodiments, the central processing station 110 displays simultaneously on the high-resolution video display 120 images representative of a selected group of the plural types of data received from the plurality of instruments 130, 132, 134, 136, 138. The displayed images can be manipulated or altered by a clinician or system operator providing commands through the integration system's control console.

In various embodiments, the inventive integration system 100 is adapted to provide “voice-recognition” control technology. A physician or system operator can, in a sterile environment, control operational aspects of the integration system, e.g., video imaging parameters, displayed data, instrument settings, recorded data, using selected voice commands. In certain embodiments, the integration system's audio communication subsystem is integrated with voice recognition control software to provide for voice-recognition control. Voice-recognition control technology can provide a voice-controlled, no-touch, control console 102, an aspect advantageous for sterile environments. In certain embodiments, the integration system 100 is operated by a user providing voice commands. As an example, preset display configurations for the main video display 120 can be called up by issuance of particular voice commands, e.g., “Carrot one,” “Carrot two,” Carrot three,” etc. The voice commands can be recognized by voice-recognition software in operation on the integration system, and certain voice commands can activate commands which are executed by the integration system or provided to instruments in communication with the system.

In certain embodiments, the integration system 100 is adapted for physician or operator control via “gesture-based” control technology. Such control technology can allow a physician, in a sterile environment, to control and customize substantially immediately various operational aspects of the integration system 100. Gesture-based control technology can be implemented with imaging apparatus, e.g., a camera capturing multi-dimensional motion, infrared or visible light sources and sensors and/or detectors detecting multidimensional motion of an object, and/or with a hand-held control device, e.g., a hand-operated device with motion sensors similar to the Wii controller. Any combination of these apparatuses can be interfaced and/or integrated with the integration system 100. In certain embodiments, the control console 102 is adapted to provide for gesture-based control of the integration system 100. Gesture-based control will give the clinician working within a sterile field, the ability to control the operation of the video integration device without touching a control panel, therefore limiting the risk of breaching a sterile barrier. In certain aspects, gesture-based control technology provides a “no-touch” control console 102.

As one example of gesture-based control, gesture-based control apparatus, e.g., a camera or imaging device, can be adapted to detect and “read” or recognize a clinician's specific hand-movements, and/or finger-pointing and/or gesturing to control which images are displayed, located and appropriately sized on a video display device 120. As another example, a clinician or system operator can hold or operate a remote motion-capture device which provides control data representative of gestures. The motion-capture device can be hand-held or attached to the operator. As another example, a clinician or system operator can don one or a pair of gloves which have a specific pattern, material, a light-emitting device, or a design embossed, printed, disposed on, or dyed into the glove. The glove can have any of the following characteristics: sterile, a surgical glove, latex or non-latex, and provided in all sizes. An imaging system and/or sensors can detect the specific pattern, light-emitting device or design and provide data representative of gestures to the integration system 100. In some embodiments, a wristband, worn by a clinician, is adapted to sense motion or provide a specific pattern or incorporate a light-emitting device. Motion of the wristband can provide data for gesture-based control of the system 100. In some embodiments, gesture-based control is based on facial expressions or gestures, e.g., winking, yawning, mouth and/or jaw movement, etc. Imaging apparatus and image processors can be disposed to detect and identify certain facial gestures.

In certain embodiments, a disposable sterile pouch is provided to encase a gesture-based control device, such as a hand-held motion-capture device. The pouch can prevent bacterial contamination from the device during medical procedures.

In certain embodiments, gestures provide for control of the system 100. The data representative of gestures can be processed by the central processing station 110 to identify commands associated with specific gestures. The central processing station 110 can then execute the commands or pass commands to a medical instrument in communication with the system. As an example, system commands can be associated with specific motion gestures. A gesture-based control apparatus can be moved in a particular gesture to produce data representative of the gesture. The central processing station 110 can receive and process the data to identify a command associated with the gesture and execute the command on the system 100. The association of a command with a gesture can be done by a system programmer, or by a user of the system.

In some embodiments, gesture-based control apparatus is used to operate a graphical user interface (GUI) on the integration system. As an example, a gesture-based control apparatus can be used to move a cursor or pointer on a GUI display, e.g., the pointer can move in substantial synchronicity with the gesture apparatus. Motion in a two-dimensional plane can position a cursor or pointer on a GUI display, and out-of-plane motion can select or activate a GUI button. The GUI can be displayed on the video-display device 120.

In some embodiments, a remote-control device includes pushbuttons or other tactile data input devices, which can be operated by a user to provide command or control data to the integration system. In certain embodiments, a remote control device includes both tactile data input devices as well as motion-capture devices which can provide data representative of gestures to the integration system.

It will be appreciated that the centralization of the control of and display of data from the plurality of medical instruments 130, 132, 134, 136, 138 by the inventive integration system 100 can free the attending surgeon and team members from certain equipment-operation and distributed data-viewing tasks, and improve focus and collaboration necessary for surgical tasks in the operating room. The integration system 100 can also free up valuable space within the operating room, and reduce clutter. Space occupied by a plurality of medical instruments which must be positioned within viewing range of the physician can be recovered, since the instruments may be moved to a remote location and a single control console and video display located near the physician. Additional details, aspects, advantages and features of the inventive integration system 100 are described below.

### III. Central Processing Station and Computing Environment

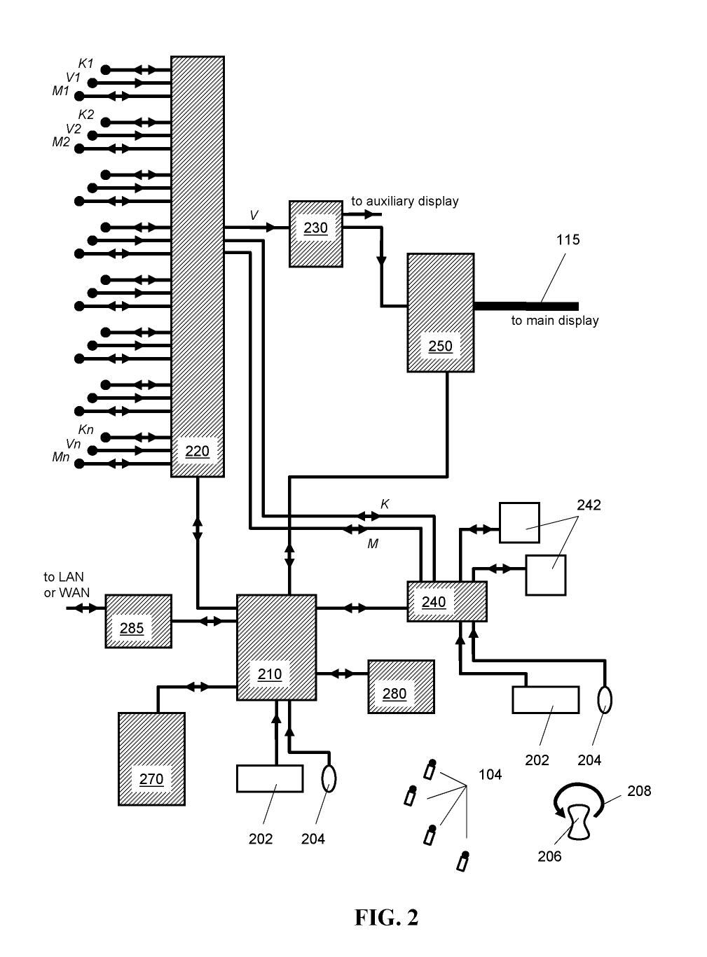

Various embodiments of a central processing station 110 are depicted in the block diagrams of FIGS. 2-4. The shaded blocks indicate elements comprising the central processing station, and unshaded blocks indicate peripheral components which can be in communication with the central processing station. In some embodiments, the peripheral components can be included with the central processing station.

The central processing station 110 can comprise a computing device or computing machine, e.g., a computer system, a personal computer, a laptop computer, one or plural central processors, one or plural microcontrollers, or one or plural microprocessors. In some embodiments, the central processing station comprises a central processing unit 210 executing computer code. The central processing station 110 can further comprise various electronic hardware in communication with the central processing station 110, e.g., one or plural data acquisition boards (not shown), one or plural audio communication boards or electronics 280 (e.g., a DX200 audio system available from HME of Poway, Calif.; a G280 mixed amplifier available from Crown International of Elkhart, Ind.), one or plural video graphics boards (not shown), one or plural internet modems 285, one or plural wireless communication modems 290, one or plural keyboard-video-mouse (KVM) switches 220, one or plural video amplifier splitters 230, one or plural digital signal processors (not shown), one or plural digital-to-analog converters (not shown), one or plural analog-to-digital converters (not shown), one or plural memory devices 270, a peripheral controller 240, or any combination of the foregoing elements. In certain embodiments, video and instrument data can be handled by a video/data wall processor, e.g., MediaWall 2500 available from RGB Spectrum of Alameda, Calif.; and digital repeater, e.g., DVI-5314b available from DVI Gear of Marietta, Ga.

In some embodiments, one or plural touchpads 242 are in communication with a peripheral controller 240, and one or plural communication devices 104 can be in communication with an audio communication board 280. In some embodiments, one or plural keyboards 202, one or plural mouse controllers 204, one or plural remote-control devices 206, and/or one or plural auxiliary monitors 205 are in communication with the central processing station 110. In some embodiments, one or plural video monitors 205 are in communication with a KVM switch 220, or video processing engine 250. In various embodiments, the central processing station 110 is in communication with a video processing engine 250, which provides data and video images for a main high-resolution display 120.

A remote-control device 206 can comprise a gesture-based control apparatus. In some embodiments, a remote-control device 206 comprises a motion-sensing device that is operated by a system user, e.g., moved in specific patterns 208 which correspond to commands recognized by the system. In some embodiments, a remote-control device 206 comprises a glove, wristband or other apparel with a specific pattern which can be imaged or sensed by a camera or imaging device. In some embodiments, a remote-control device 206 comprises a glove, wristband or other apparel with a light-emitting device, e.g., a laser, LED, organic light-emitting diode, for which the emitted light can be detected by one or plural optical sensors. In some embodiments, a remote-control device 206 comprises a handheld device with either or both a specific pattern and light-emitting device. In some embodiments, the remote-control device 206 comprises a handheld device adapted for gesture-based operation and including tactile data input controls, e.g., pushbuttons, keypads, etc.

The phrase “command recognized by the system” pertains to control or command data produced by an input device, e.g., audio device 104, mouse controller 204, keyboard 202, remote-control device 206, and the like, which can be processed by the central processing station and identified as a command to affect operation of the system. In some embodiments, the control or command data is associated with a predefined section of executable computer code. Upon receiving a particular control or command data, the central processing station executes the section of code associated with the particular command. The association of a particular command with a particular section of executable code can be established during development of the integration system or by a system user, e.g., a user identifying particular sections of executable codes to be associated with particular voice commands or gestures.

In some embodiments as depicted in FIG. 2, data from a plurality of medical instruments are received by a KVM switch 220. The data received can include digital data or analog data derived from various physiological sensors and can include video data derived from various medical imaging instruments. The KVM switch 220 can include bi-directional data lines, e.g., bi-directional data lines for keyboard data K1, K2, . . . Kn, and bidirectional data lines for mouse controller data M1, M2, . . . Mn. The KVM switch 220 can further include video input lines V1, V2, . . . Vn. Each keyboard-video-mouse data set, e.g., K1, V1, M1, can be associated with a single medical instrument, e.g., a robotic catheter manipulation system. The KVM switch 220 can be in communication with the central processing unit 210, and commands from a control console 102, handled by the central processor and passed to the KVM switch 220, can select one or plural keyboard-video-mouse data sets for activation and/or display on the main display 120. In various embodiments, commands from a control console 102 are passed back to one of the medical instruments 130, 132, 134, 136, 138. When a particular data set is activated, e.g., a data set corresponding to one medical instrument 134, then the instrument becomes controllable by a user entering commands from a control console 102, or inputting voice commands through an audio device 104, or inputting commands through a touchpad 242, or via remote-control device 206. In certain embodiments, voice-recognition software executes on the central processing unit 210 and translate voice commands received through the audio communication board 280 into recognizable system commands or instrument commands, e.g., commands to alter the display configuration of the video display 120 or to alter a setting on one of the medical instruments 130, 132, 134, 136, 138. In various embodiments, system commands affect operation of the inventive integration system 100, and instrument commands affect operation of one or plural peripheral medical instruments 130, 132, 134, 136, 138. In various embodiments, the control of different medical instruments in communication with the integration system 100 is seamlessly switchable from one instrument to the next from a single control console 102.

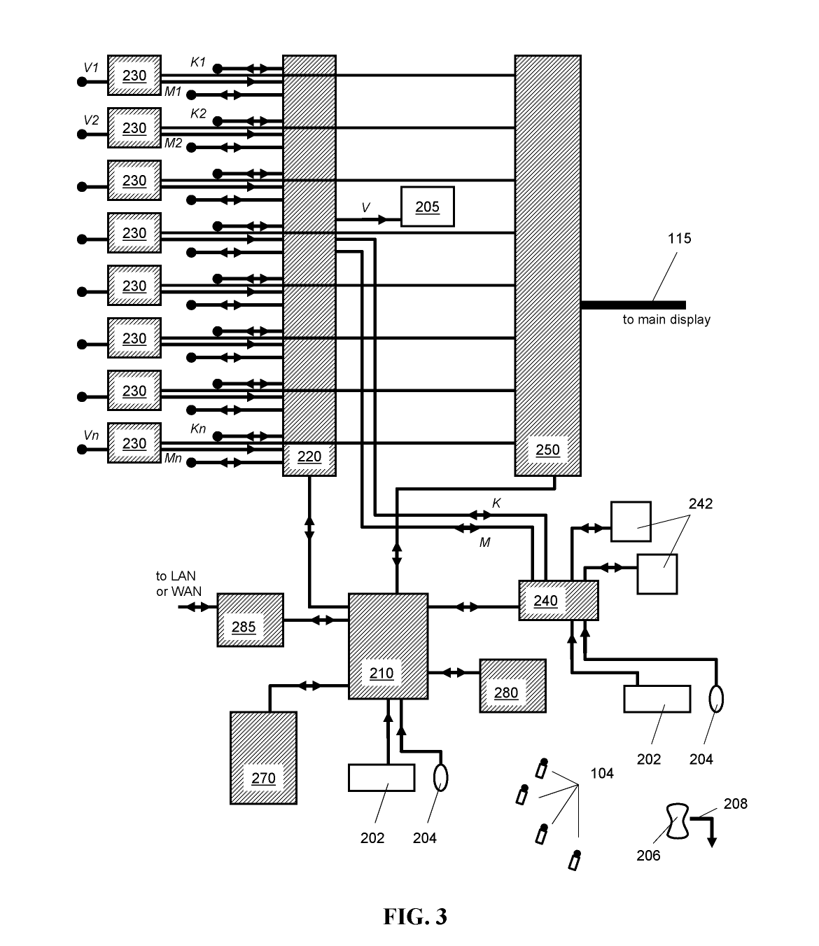

In various embodiments, selected data, designated K, V, M in FIGS. 2-3 is output from the KVM switch 220. In some embodiments, video data V is sent to a video amplifier splitter 230 where the video signal can be split and amplified. Outputs from the video amplifier splitter 230 can be displayed on an auxiliary monitor or display 205, e.g., a backup display, or a second display located in a control room, and can be fed into a video processing engine 250.

In various embodiments, keyboard K and mouse M data is fed to peripheral controller 240. In some embodiments, the keyboard K and mouse M data is fed directly to a keyboard 202 and mouse controller 204. In yet other embodiments, the keyboard K and mouse M data is fed to the central processing unit 210.

The peripheral controller 240 can be in communication with the central processing unit 210, one or plural touchpad controllers 242, a keyboard 202, a mouse controller 204, and remote-control device 206. The peripheral controller 240 can receive command inputs from the one or plural touchpads 242, a keyboard 202, a mouse controller 204, remote-control device 206, the central processing unit 210, or any combination thereof and relay commands back to a medical instrument through the KVM switch. In some embodiments, commands received by the peripheral controller are passed through and optionally processed by the central processing unit 210 and transmitted to one or plural medical instruments.

In some embodiments, a touchpad 242, keyboard 202, mouse controller 204, remote-control device 206, and auxiliary monitor or display 205 are located in a control room. The control room can be remote from the operating room, or a partitioned room adjacent the operating room. In certain embodiments, partial or full control of the inventive integration system 100 is executed from the touchpad 242, keyboard 202, mouse controller 204, or remote-control device 206, located in the control room. In some embodiments, the integration system 100 provides a cursor on the main high-resolution video display 120 which can be moved and altered using the touchpad 242, keyboard 202, and/or mouse controller 204 located in the control room. This can allow a control-room participant to draw the attention of an operating-room participant to particular data displayed on the main high-resolution video display 120.

In various embodiments, the video processing engine 250 prepares data for display on the high-resolution video display device 120. The high-resolution video display 120 can comprise a 56-inch, 8 megapixel flat-panel monitor, e.g., an LCD flat panel display model P56QHD available from Toshiba of Simi Valley, Calif. In various aspects, the high-resolution display provides for improved accurate and detailed identification of certain physiological features. The video processing engine 250 can accept video data in one or plural data formats and output video data in a format suitable for display on a high-resolution video-display 120.

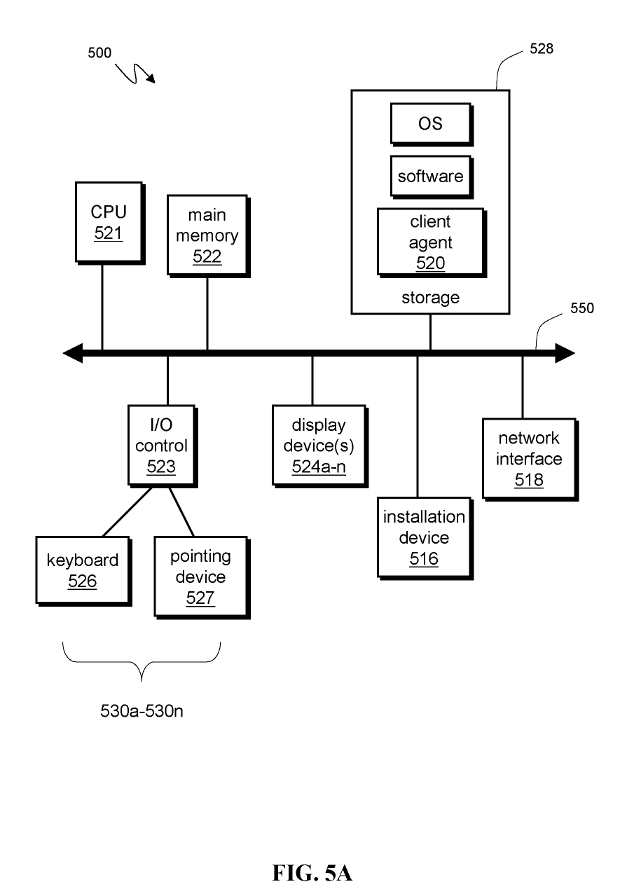

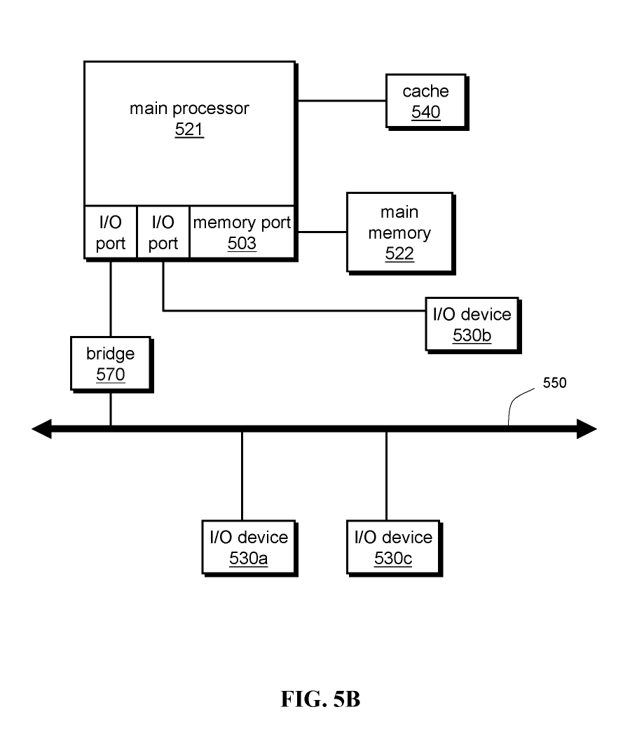

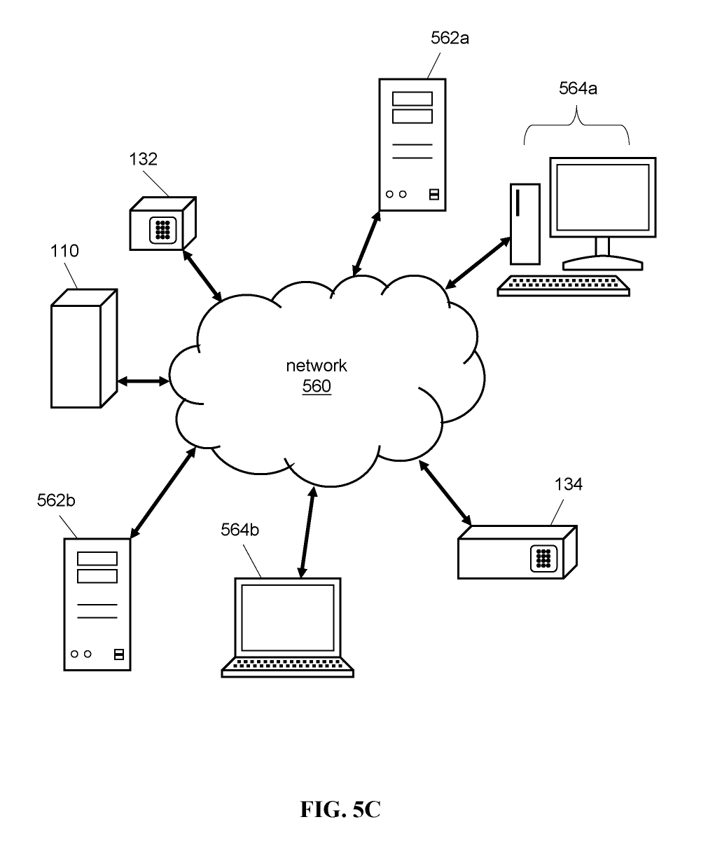

Further details about the central processing station 110 and its computing environment will now be provided. In certain embodiments, the central processing station 110 comprises a computing device or machine 500 as depicted in FIG. 5A. Included within the computing device 500 is a system bus 550 that communicates with the following components: a central processing unit 521; a main memory 522; storage memory 528; an input/output (I/O) controller 523; display devices 524a-524n; an installation device 516; and a network interface 518. In one embodiment, the storage memory 528 includes: an operating system, software routines, and a client agent 520. The I/O controller 523, in some embodiments, is further connected to a key board 526, and a pointing device 527. Other embodiments may include an I/O controller 523 connected to more than one input/output device 530a-530n.

FIG. 5B illustrates an additional embodiment of a computing device 500. Included within the computing device 500 is a system bus 550 that communicates with the following components: a bridge 570, and a first I/O device 530a. In some embodiments, the bridge 570 is in further communication with the central processing unit 521, where the central processing unit 521 can further communicate with a second I/O device 530b, a main memory 522, and a cache memory 540. Included within the central processing unit 521, are I/O ports, a memory port 503, and a main processor.

Embodiments of the computing machine 500 can include a central processing unit 521 characterized by any one of the following component configurations: logic circuits that respond to and process instructions fetched from the main memory unit 522; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits capable of executing the systems and methods described herein. Still other embodiments of the central processing unit 521 may include any combination of the following: a microprocessor, a microcontroller, a central processing unit with a single processing core, a central processing unit with two processing cores, or a central processing unit with more than one processing core.

One embodiment of the computing machine 500 includes a central processing unit 521 that communicates with cache memory 540 via a secondary bus also known as a backside bus, while another embodiment of the computing machine 500 includes a central processing unit 521 that communicates with cache memory via the system bus 550. The local system bus 550 can, in some embodiments, also be used by the central processing unit to communicate with more than one type of I/O devices 530a-530n, as well as various medical instruments 130, 132, 134, 136, 138. In some embodiments, the local system bus 550 can be any one of the following types of buses: a VESA VL bus; an ISA bus; an EISA bus; a MicroChannel Architecture (MCA) bus; a PCI bus; a PCI-X bus; a PCI-Express bus; or a NuBus. Other embodiments of the computing machine 500 include an I/O device 530a-530n that is a video display 524 that communicates with the central processing unit 521 via an Advanced Graphics Port (AGP). Still other versions of the computing machine 500 include a processor 521 connected to an I/O device 530a-530n via any one of the following connections: HyperTransport, Rapid I/O, or InfiniBand. Further embodiments of the computing machine 500 include a communication connection where the processor 521 communicates with one I/O device 530a using a local interconnect bus and with a second I/O device 530b using a direct connection.

Included within some embodiments of the computing device 500 is each of a main memory unit 522 and cache memory 540. The cache memory 540 will in some embodiments be any one of the following types of memory: SRAM; BSRAM; or EDRAM. Other embodiments include cache memory 540 and a main memory unit 522 that can be any one of the following types of memory: Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), or any other type of memory device capable of executing the systems and methods described herein. The main memory unit 522 and/or the cache memory 540 can in some embodiments include one or more memory devices capable of storing data and allowing any storage location to be directly accessed by the central processing unit 521. Further embodiments include a central processing unit 521 that can access the main memory 522 via one of either: a system bus 550; a memory port 503; or any other connection, bus or port that allows the processor 521 to access memory 522.

One embodiment of the computing device 500 provides support for any one of the following installation devices 516: a floppy disk drive for receiving floppy disks such as 3.5-inch, 5.25-inch disks or ZIP disks, a CD-ROM drive, a CD-R/RW drive, a DVD-ROM drive, tape drives of various formats, USB device, a bootable medium, a bootable CD, a bootable CD for GNU/Linux distribution such as KNOPPIX®, a hard-drive or any other device suitable for installing applications or software. Applications can in some embodiments include a client agent 520, or any portion of a client agent 520. The computing device 500 may further include a storage device 528 that can be either one or more hard disk drives, or one or more redundant arrays of independent disks; where the storage device is configured to store an operating system, software, programs applications, or at least a portion of the client agent 520. A further embodiment of the computing device 500 includes an installation device 516 that is used as the storage device 528.

Furthermore, the computing device 500 may include a network interface 518 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). One version of the computing device 500 includes a network interface 518 able to communicate with additional computing devices via any type and/or form of gateway or tunneling protocol such as Secure Socket Layer (SSL) or Transport Layer Security (TLS), or the Citrix Gateway Protocol manufactured by Citrix Systems, Inc. Versions of the network interface 518 can comprise any one of: a built-in network adapter; a network interface card; a PCMCIA network card; a card bus network adapter; a wireless network adapter; a USB network adapter; a modem; or any other device suitable for interfacing the computing device 500 to a network capable of communicating and performing the methods and systems described herein.

Embodiments of the computing device 500 can include any one of the following I/O devices 530a-530n: a keyboard 526; a pointing device 527; a mouse; a gesture-based remote control device; an audio device; trackpads; an optical pen; trackballs; microphones; drawing tablets; video displays; speakers; inkjet printers; laser printers; and dye-sublimation printers; or any other input/output device able to perform the methods and systems described herein. An I/O controller 523 may in some embodiments connect to multiple I/O devices 530a-530n to control the one or more I/O devices. Some embodiments of the I/O devices 530a-530n may be configured to provide storage or an installation medium 516, while others may provide a universal serial bus (USB) interface for receiving USB storage devices such as the USB Flash Drive line of devices manufactured by Twintech Industry, Inc. Still other embodiments of an I/O device 530 may be a bridge between the system bus 550 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 500 can connect to multiple display devices 524a-524n, in other embodiments the computing device 500 can connect to a single display device 524, while in still other embodiments the computing device 500 connects to display devices 524a-524n that are the same type or form of display, or to display devices that are different types or forms, e.g., one display can be a 56″ high-resolution main display while others can be standard video monitors and/or flat panel displays. Embodiments of the display devices 524a-524n can be supported and enabled by the following: one or multiple I/O devices 530a-530n; the I/O controller 523; a combination of I/O device(s) 530a-530n and the I/O controller 523; any combination of hardware and software able to support a display device 524a-524n; any type and/or form of video adapter, video card, driver, and/or library to interface, communicate, connect or otherwise use the display devices 524a-524n. The computing device 500 may in some embodiments be configured to use one or multiple display devices 524a-524n, these configurations include: having multiple connectors to interface to multiple display devices 524a-524n; having multiple video adapters, with each video adapter connected to one or more of the display devices 524a-524n; having an operating system configured to support multiple displays 524a-524n; using circuits and software included within the computing device 500 to connect to and use multiple display devices 524a-524n; and executing software on the main computing device 500 and multiple secondary computing devices to enable the main computing device 500 to use a secondary computing device's display as a display device 524a-524n for the main computing device 500. Still other embodiments of the computing device 500 may include multiple display devices 524a-524n provided by multiple secondary computing devices and connected to the main computing device 500 via a network.

In some embodiments of the computing machine 500, an operating system may be included to control task scheduling and access to system resources. Embodiments of the computing device 500 can run any one of the following operation systems: versions of the MICROSOFT WINDOWS operating systems such as WINDOWS 3.x; WINDOWS 95; WINDOWS 98; WINDOWS 2000; WINDOWS NT 3.51; WINDOWS NT 4.0; WINDOWS CE; WINDOWS XP; WINDOWS VISTA; and WINDOWS 7; the different releases of the Unix and Linux operating systems; any version of the MAC OS manufactured by Apple Computer; OS/2, manufactured by International Business Machines; any embedded operating system; any real-time operating system; any open source operating system; any proprietary operating system; any operating systems for mobile computing devices; or any other operating system capable of running on the computing device and performing the operations described herein. One embodiment of the computing machine 500 has multiple operating systems installed thereon.

The computing machine 500 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a device of the IPOD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In certain embodiments the computing machine 500 can be a mobile device such as any one of the following mobile devices: a JAVA-enabled cellular telephone or personal digital assistant (PDA), such as the i55sr, i58sr, i85s, i88s, i90c, i95cl, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein. Still other embodiments of the computing environment 101 include a mobile computing device 500 that can be any one of the following: any one series of Blackberry, or other handheld device manufactured by Research In Motion Limited; the iPhone manufactured by Apple Computer; any handheld or smart phone; a Pocket PC; a Pocket PC Phone; or any other handheld mobile device supporting Microsoft Windows Mobile Software.

In certain embodiments, the central processing station as described above functions as a client machine within a local area network or a wide area network. In some embodiments, the central processing station functions as a server in a local area network or a wide area network. Plural computers, servers and/or medical instruments can be in communication with the central processing station 110 through a local area network, medium area network, and/or a wide area network. An embodiment of a network 560 is depicted in FIG. 5C. It will be appreciated that any node of the network can be connected to another network, e.g., to a WAN, a MAN, or LAN.

When configured to function as a client machine, the central processing station 110 can in some embodiments execute, operate or otherwise provide an application that can be any one of the following: software; a program; executable instructions; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other type and/or form of executable instructions capable of executing on the central processing station 110. Still other embodiments may include a computing environment with an application that is any of either server-based or remote-based, and an application that is executed on a server 562a on behalf of the central processing station 110. Further embodiments of the computing environment include a server 562a configured to display output graphical data to the central processing station 110 using a thin-client or remote-display protocol, where the protocol used can be any one of the following protocols: the Independent Computing Architecture (ICA) protocol manufactured by Citrix Systems, Inc. of Ft. Lauderdale, Fla.; or the Remote Desktop Protocol (RDP) manufactured by the Microsoft Corporation of Redmond, Wash.

In one embodiment, the central processing station 110 can be a virtual machine such as those manufactured by XenSolutions, Citrix Systems, IBM, VMware, or any other virtual machine able to implement the methods and systems described herein.

The computing environment can, in some embodiments, include plural servers 562a, 562b, where the servers are: grouped together as a single server entity, logically-grouped together in a server farm; geographically dispersed and logically grouped together in a server farm, located proximate to each other and logically grouped together in a server farm. Geographically dispersed servers within a server farm can, in some embodiments, communicate using a wide area network (WAN), medium area network (MAN), or local area network (LAN), where different geographic regions can be characterized as: different continents; different regions of a continent; different countries; different states; different cities; different campuses; different rooms; or any combination of the preceding geographical locations. In some embodiments the server farm can be administered as a single entity or in other embodiments can include multiple server farms. The computing environment for the central processing station 110 can include more than one server grouped together in a single server farm where the server farm is heterogeneous such that one or a subgroup of servers is configured to operate according to a first type of operating system platform (e.g., WINDOWS NT, manufactured by Microsoft Corp. of Redmond, Wash.), while one or more other servers are configured to operate according to a second type of operating system platform (e.g., Unix or Linux).

In some embodiments, the central processing station 110 is located in a computing environment which includes one or plural servers configured to provide the functionality of any one of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server configured to operate as an active direction; a server configured to operate as application acceleration application that provides firewall functionality, application functionality, or load balancing functionality, or other type of computing machine configured to operate as a server. In some embodiments, a server can include a remote authentication dial-in user service such that the server is a RADIUS server. For embodiments of the computing environment where the server comprises an appliance, the server can be an appliance manufactured by any one of the following manufacturers: the Citrix Application Networking Group; Silver Peak Systems, Inc; Riverbed Technology, Inc.; F5 Networks, Inc.; or Juniper Networks, Inc. Some embodiments include a server with the following functionality: receives requests from a the central processing station 110, forwards the request to a second server, and responds to the request generated by the central processing station 110 with a response from the second server; acquires an enumeration of applications available to the client machines 564a, 564b within the network and address information associated with a server hosting an application identified by the enumeration of applications; presents responses to client requests using a web interface; communicates directly with the central processing station 110 to provide the central processing station 110 with access to an identified application; receives output data, such as display data, generated by an execution of an identified application on the server.

In certain embodiments, a server on the network, or the central processing station 110 functioning as a server, can be configured to execute any one of the following applications: an application providing a thin-client computing or a remote display presentation application; any portion of the CITRIX ACCESS SUITE by Citrix Systems, Inc. like the METAFRAME or CITRIX PRESENTATION SERVER; MICROSOFT WINDOWS Terminal Services manufactured by the Microsoft Corporation; or an ICA client, developed by Citrix Systems, Inc. Another embodiment includes a server configured to execute an application so that the server may function as an application server such as any one of the following application server types: an email server that provides email services such as MICROSOFT EXCHANGE manufactured by the Microsoft Corporation; a web or Internet server; a desktop sharing server; or a collaboration server. Still other embodiments include a server that executes an application that is any one of the following types of hosted servers applications: GOTOMEETING provided by Citrix Online Division, Inc.; WEBEX provided by WebEx, Inc. of Santa Clara, Calif.; or Microsoft Office LIVE MEETING provided by Microsoft Corporation.

In one embodiment, a server on the network, or the central processing station 110 functioning as a server may be a virtual machine such as those manufactured by XenSolutions, Citrix Systems, IBM, VMware, or any other virtual machine able to implement the methods and systems described herein.

It will be appreciated that the central processing station 110 may function, in some embodiments, as a client node seeking access to resources provided by a server 562a on the network, or as a server providing other clients 564a, 564b, and/or instruments 132, 134 on the network with access to hosted resources. One embodiment of the computing environment includes a server that provides the functionality of a master node. As an example, the central processing station 110 may communicate with other clients through the master node server. One embodiment of the computing environment includes the central processing station 110 that communicates over the network requests for applications hosted by a master server or a server in a server farm to be executed, and uses the network to receive from the server output data representative of the application execution.

In certain embodiments, a Linux kernel is installed on one or plural medical instruments 132, 134. The Linux kernel adapts the host instrument to communicate with and provide data to the central processing station 110 over the network 560. In certain embodiments, data is received from plural instruments hosting Linux kernels and handled by a video/data wall processor, e.g., Media Wall 2500 available from RGB Spectrum, within the central processing station. The wall processor can provide the functionality of a KVM switch. Data from the wall processor can be split with a digital repeater, e.g., a DVI-5314b available from DVI Gear, to provide data streams for a main display 120, streaming data for viewing over the network, and data for recordation. In certain embodiments, data for recordation is combined downstream with audio data before it is recorded.

The network 560 between the central processing station 110 and a server, client, and/or instrument is a connection over which data is transferred between the central processing station 110 and the server, client, or instrument. In various embodiments, the network connects the central processing station 110 with client machines, instruments, and/or servers. The network 560 can be any of the following: a local-area network (LAN); a metropolitan area network (MAN); a wide area network (WAN); a primary network comprised of multiple sub-networks located between the client machines and the servers; a primary public network with a private sub-network; a primary private network with a public sub-network; or a primary private network with a private sub-network. Still further embodiments include a network that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; a network that includes a wireless link where the wireless link can be an infrared channel or satellite band; or any other network type able to transfer data from the central processing station 110 to client machines and/or servers and vice versa to accomplish the methods and systems described herein. Network topology may differ within different embodiments, possible network topologies include: a bus network topology; a star network topology; a ring network topology; a repeater-based network topology; and a tiered-star network topology. Additional embodiments may include a network of mobile telephone networks that use a protocol to communicate among mobile devices, where the protocol can be any one of the following: AMPS; TDMA; CDMA; GSM; GPRS UMTS; or any other protocol able to transmit data among mobile devices to accomplish the systems and methods described herein.

It will be appreciated that the integration system 100 can provide for remote internet access via an internet modem 285 or network interface 518. In various embodiments, remote access via a LAN or WAN is used to operate the integration system 100, or to participate in viewing an ongoing medical procedure. In some embodiments, a remote participant can have video access, audio access, and optionally electronic chalkboard access to an integration system 100 in use at a distant facility. Remote audio access can be provided over an LAN, MAN, or WAN or telephone network. Remote access can be used to participate in a surgical procedure from a remote location, e.g., a specialist can monitor a case as it occurs and provide assistance from locations near or far removed from the operating room. In some embodiments, remote access is used to run diagnostics of the inventive integration system 100, or to upgrade software executed on the system. In some embodiments, remote access is used to review one or more surgical cases. In certain embodiments, the remote access is used for instructional purposes, e.g., for live observation of a complex surgical procedure by interns. In various embodiments, the inventive integration system 100 supports inter-frame data compression of data transmitted over a LAN, MAN, or WAN.

### IV. Aspects of Data Display

In various embodiments, the main high-resolution data display 120 comprises a high-resolution, large-screen, video display, e.g. a 56-inch, 8 megapixel flat panel monitor or the like. The display 120 can be located in an operating room or procedure room near an attending clinician. The display 120 provides multiple, high-quality images and data representations, e.g., charts, graphs, level indications, etc., derived from data produced by a plurality of medical instruments 130, 132, 134, 136, 138.

In some embodiments, at least one high-resolution display device 120 used with the system 100 comprises apparatus adapted to display a holographic image. The display device 120 can comprise a holographic projection system for projecting a three-dimensional image. The displayed holographic image can be projected by hologram technology to provide a three-dimensional (3D) representation of an organ or region of physical anatomy. In some embodiments, the displayed image can be a clinically generated image provided in 3D holographic format. The holographic image can be rotated, dissected and repositioned upon data command input to the system to aid in clinical diagnosis, treatment, and/or education.

As an example, system 100 can provide video data to display device 120 which generates a 3D holographic image of a patient's heart. The display can include representations of catheters used in a procedure on the heart, and provide a real-time visual guide to assist in the placement of the catheters as well as display the location of cardiac ablations. The display can provide a 3D mapping of the heart, and be manipulated at the discretion of the clinician. As an additional visual aid, selected cross-sectional views of the 3D image can be displayed substantially simultaneously on a second display device 120, e.g., a flat-panel, high-resolution video screen.

In certain embodiments, the system 100 is adapted to provide electronic chalkboard operation for one or plural video display devices 120, 205. In electronic chalkboard operation, a system user can electronically mark or annotate a feature on a display device 120 of the system so that others can view the marked or annotated feature on the same display or auxiliary displays in operation with the system 100. A system user can identify a particular item on a display with a pointer, draw circles, lines, arrows, words, etc. so that the markings are visible on all display devices 120, 205 in operation with the system. In some embodiments, the marking or annotation are made within a 3D holographic image. Electronic annotation can be provided by an electronic, magnetic, optical, or electromagnetic marking device, such as a magnetic-tipped pen or optical diode pointer device. Additionally, electronic annotation can be provided via remote-control device 206. In some embodiments, markings and annotation are made with a motion-gesture or motion-sensing marking device, e.g., a device which provides data for electronic annotation on a display in response to movement of the device.

In some embodiments, the integration system is adapted to provide multi-way electronic chalkboard operation. In multi-way electronic chalkboard operation, plural system users can electronically mark or annotate features on a display device. Each marking may be color coded to identify its creator. In certain embodiments, the integration system is configured such that one or a selected set of users can remove the markings or annotations.

Annotation marked on a display can be transient, semi-permanent, or permanent until erased. In some embodiments, where markings are made by a motion-gesture device, annotation is provided in a trace-then-write mode. As an example, a motion-gesture marking device can initiate display of a transient and faint or semi-transparent trace on one or plural system display devices 120, 205 as the marking device is moved. The trace can fade to no marking within about one second, within about one-half second, and yet within about one-quarter second in some embodiments. In certain embodiments, the persistence of the trace is adjustable by a system user to be any value between about two seconds and about one-tenth of a second. The fading trace can assist the operator in determining where a marking will be made on a display. In certain embodiments, when the trace arrives at a location where a more permanent marking is desired, an operator can push a button on the marking device to make semi-permanent, or permanent until erased, subsequent markings. Semi-permanent markings can persist on system display devices for time periods of any value, adjustable by a system operator, between about two seconds and about 10 minutes after which the markings will automatically fade to no marking. Markings can also be selected to be permanent until erased. Such markings remain on system displays until a command is issued to erase the annotations. The types of markings, e.g., transient, semi-permanent, permanent until erase, can be selected by push-button or voice commands. The annotations can be “push-button” or voice-command erasable, e.g., by pushing a button on the marking device or issuing a voice command to the system 100. The semi-permanent and permanent markings can be semi-transparent so as not to completely occlude image data behind a marking.

In certain embodiments, a marking device or remote-control device 206 provides control of a pointer visibly displayed on one or plural display devices. The pointer can be permanently on or blinking, and moves in response to movement of the marking device. The pointer can be used to point to or draw attention to particular items on a display device 120. In some embodiments, the pointer is used in conjunction with a graphical user interface.

In various embodiments, annotations are used for assistance, instructional, oversight, clinical review, or analytical purposes. In certain embodiments, the system is adapted for two-way electronic chalkboard operation. As an example, a senior or first physician can be located in a control room or remote location while a second physician, e.g., another physician, fellow or Physician's Assistant, carries out an invasive procedure in an operating room or procedure room. The first physician can monitor the procedure and communicate with the second physician via audio and graphical mode, e.g., voice communication over the audio communication subsystem and annotations which are displayed on the main display device 120. The first physician can point to and identify specific items, e.g., features of anatomy, data displayed from various monitoring equipment, vital signs, etc., which are displayed on the main display 120. The first physician can make the annotations on an auxiliary display 205 located in the control room or remote location, yet these markings will be simultaneously displayed in the operating room. Additionally, the second physician can make annotations, via gesture-based marking, on the main display 120 in the operating room, which are simultaneously displayed on the auxiliary display located with the first physician.

In various embodiments, the video processing engine 250 is in communication with the central processing unit 210 and can receive video display commands from the central processing unit. The video processing engine 250 can adjust the size of any displayed image, alter the color, contrast and/or brightness of any displayed image, adjust the position of any displayed image, and change the number and/or selection of displayed images in accordance with commands received from the central processing unit 210. In certain embodiments, the displayed images are “right sized,” e.g., automatically sized to substantially eliminate image voids in the high-resolution video display 120

In various embodiments, the video processing engine 250 provides for video mixing and image layering. The video processing engine 250 can prepare for display on the high-resolution display 120, substantially simultaneously, up to 12 different data streams received from a plurality of medical instruments. In some embodiments, the video processing engine 250 prepares up to 16 different data streams for display on the high-resolution display 120. In certain embodiments, integration system provides for control and management of data streams from as many as 24 different sources. Each data stream can contain dynamic or static video image data, data associated with chart traces, as well as instrument status indicators. Groups of data displayed on the system's video display 120 can be changed by commands provided through a control console. Some instrument data can be dropped from the display and other instrument data added to the display based upon commands provided to the integration system. Additional data can be layered over any one image by the video processing engine. In some embodiments, the video processing engine 250 can enlarge and display a single image from one data stream at full-screen view, e.g., an image can be enlarged temporarily in response to a command from an attending physician. In some embodiments, an image can be enlarged temporarily on an automated basis in response to a cautionary status indicator received at the central processing unit 210 from a particular medical instrument.

In various embodiments, the images are displayed by the video processing engine 250 according to preset display configurations. For example, a user can select a particular group of medical instruments for which a video display is desired, and select a size for each of the displayed data-stream images. A user can compose several display configurations, and save parameters associated with each configuration in a system memory device 270. Any preset display configuration can be recalled upon start-up, or during operation of the inventive integration system 100. Preset configurations can be selected by providing an input into a touchpad 242, keyboard 202, mouse controller 204, or remote-control device 206, or by providing voice commands at an audio device 104. Accordingly, a user can rapidly toggle the display between a number of different preset display configurations. In some embodiments, the preset configurations are editable or customizable in real time, e.g., while the system is in use.

In some embodiments, the video processing engine 250 receives video input from an intermediary device, e.g., a KVM switch as depicted in FIG. 2. In some embodiments, the video processing engine 250 receives a plurality of video inputs indirectly, or directly, from medical instruments as depicted in FIG. 3. In some embodiments, video inputs are split and/or amplified prior to being fed into the video processing engine 250, or fed directly into the video processing engine. In certain embodiments, the video processing engine provides output for a single high-resolution display 120 and for a second auxiliary or back-up display. The second display can be located in a partitioned control room, or can be located within the operating room. In some embodiments, video displays from existing equipment, e.g., biplane fluoroscopy displays, are retained and/or paired with the high-resolution display 120. The retained displays can provide back-up imaging security, or free up imaging space on the high-resolution display.

### V. Audio Communication Subsystem

In various embodiments, the inventive integration system 100 includes an audio communication subsystem. The audio communication subsystem can be a multi-way, high-fidelity system providing multi-way audio communications between members using the integration system. The audio communication subsystem can comprise an audio communication board 280 in communication with one or plural audio communication devices 104. An audio communication device can be an audio sensor, e.g., microphone, or indicator, e.g., speaker, ear jack, or a combination sensor and indicator, such as a wireless head set. An audio communication device 104 can be operated by each member of an attending surgical team. In certain embodiments, the audio communication subsystem provides whisper-sensitive, recordable, and private wireless communications for up to 16 participants. Communication links between different audio devices and the audio communication board 280 can be wired or wireless. In some embodiments, the communication links are established via wireless RF signals. In various aspects, any one of the attending team members can remain in constant communication the with surgical team, even though departing from the operating room. In various embodiments, audio communications are handled and/or processed by the audio communication board 280. In some embodiments, audio communications are passed to the central processing unit 210 for storage in memory, e.g., storage in memory device 270.

In various embodiments, the audio communication subsystem eliminates the need for a room-wide intercom system, e.g., a intercom system between the operating room and a partitioned or remote control room. Such a room-wide system can be loud and distracting or disturbing to team members and non-sedated patients. Additionally, the room-wide intercom system is public. In various embodiments, the audio communication subsystem for the inventive integration system 100 provides high-fidelity, whisper-sensitive, private communications among team members. The audio communication devices 104 can be operated in push-to-talk mode or full duplex mode at the user's preference. In various embodiments, audio signals from any of the team members is delivered to all participants. In various embodiments, the audio communication subsystem provides hands-free operation between all participants in the operating room and in a partitioned or remote control room.

In certain embodiments, the audio system further provides for the inclusion of background music. In some cases, background music can be soothing to a patient, and beneficial to an attending surgeon. In various embodiments, a background music signal can be added to the audio signal delivered to any one or all participants. In some embodiments, background music is provide to public speakers within the facility and not to audio devices 104 in use by system users. In various aspects, the audio communication subsystem accepts audio input from compact disc players, MP3 players, portable music-storage devices, or internet music servers.

### VI. Data Recordation

In various embodiments, the inventive integration system 100 provides for integrated recording of data associated with a surgical case. Any or all of the plural types of data generated by medical instruments 130, 132, 134, 136, 138, data produced through audio communication devices 104, and user input commands from peripheral controls 202, 204, 242 can be integrated into a single, synchronized, common data stream. This data can be monitored by the central processing unit 210 and stored in memory device 270. In certain embodiments, the synchronized data stream is indexed as it is stored.

An advantage of the inventive integration system 100 is that all data can be stored as a common data stream, and subsequently retrieved, from a central database. An additional advantage is that all data can be stored synchronously, as it happens, such that it can later be reviewed as it would be perceived at the time of its original occurrence. It will be appreciated that synchronous data storage of an integrated, common data stream in a central database greatly reduces data-handling tasks that would be associated with retrieving and reviewing data from a plurality of different medical instruments. The integration of data provided by the inventive system 100 provides an advantage in data handling, management, and retrieval that extends beyond a simple combination of the plurality of medical instruments.

In certain embodiments, voice commands are used to mark or index data for storage, and facilitate subsequent retrieval. For example, significant events that occur during a surgical procedure can be marked by a voice command from the team leader. A voice command received from an audio communication board 280 can cause the central processing unit 210 to associate a searchable index at a particular location in a data stream as the data is stored. In some embodiments, time stamps can be associated with the data stream as it is stored. In certain embodiments, the data stream is indexed on an automated basis by software executing on the central processing station 110, or can be indexed manually by a team member. In various embodiments, the data is retrievable, searchable and reviewable according to an index, and/or according to associated time stamps or index markings.

In various embodiments, data stored by the inventive integration system 100 provides an accurate and realistic representation of actual surgical case, and can be used subsequently for instructional purposes or diagnostic purposes. In certain embodiments, the synchronously and centrally stored data is useful for subsequent computational and/or statistical analysis. In various embodiments, data warehouses are compiled for similar surgical cases, and software used to analyze data from a plurality of recorded cases. In various embodiments, the synchronized data is provided for computer and/or statistical analysis.

### VII. Instructional Code and Modes of Operation

In various modes of operation of the inventive integration system 100, customized or customizable software is executed on the central processing unit 210. The software can provide for communications and data exchange between medical instruments 130, 132, 134, 136, 138, audio devices 104, peripheral controls 202, 204, 206, 242, memory devices 270, and other associated hardware, e.g., KVM switch 220, wall processor, video processing engine 250, wireless communication modem 290, touchpad controller 240, audio communication modem 280, internet modem 285, in communication with the central processing unit 210. The software can provide for rapid customization of the inventive integration system for different or unique hardware configurations, e.g., additional or fewer medical instruments, medical instruments with non-standard data formats and communication protocols, additional or fewer peripheral devices, and additional, fewer, or novel hardware components in use with the integration system 100.

In various embodiments, proprietary software or firmware provides graphical user interface control for operation of all medical instruments, data management, data recording, and data display. In some embodiments, the software provides for touchpad control, e.g., displays buttons or selections on one or plural remote touchpad controllers 242, and/or remote control via gesture-based or voice-recognition control technology. In certain embodiments, the software generates dashboard images or display widgets on a peripheral control screen or on the main high-resolution video display 120. In certain embodiments, a dashboard image displays a customizable extract of selected data or information. In some embodiments, the software provides an integrated audit trail for each surgical case, and can code or mark case data for efficient retrieval and review. In some embodiments, the software includes analytical routines to numerically evaluate data recorded for one or plural surgical cases, and compile statistical data from the evaluation. In some embodiments, analysis of data is carried out during a complex surgical procedure. In various embodiments, the software provides comparison of pre-case data and post-intervention data. Data comparisons can be displayed and reviewed on the main display 120 at any time during or after surgical procedures. The comparison of pre-intervention and post-intervention data can provide a rapid and convenient indication of success of the procedure.

In some embodiments, software or firmware in operation on the central processing unit 210 can enable and disable electronic chalkboard operation on system displays 120, 205. As an example, software executing on the processing unit 210 provides an “annotation” icon on any one or plural of system displays and/or control panels. When a clinician or system operator selects the icon, the software provides for electronic chalkboard operation, as described above, to allow a clinician or system operator to make markings on a system display device 120, 205.

In certain embodiments, computer code or software or firmware is provided to allow a physician or system operator to facilely customize and control operational aspects of the integration system 100, such as imaging parameters, data recording and data display. The software applications can be compatible with popular personal electronic devices, e.g., Apple iPhone, iPod-Touch or any other handheld PDA, etc. The software applications can allow a clinician to design multiple “preset” configurations and/or identify any one configuration to alter operational aspects of the integration system 100, e.g., data and image selection, video display layout, image location and size, medical instrument parameters, etc. The preset configurations can be designed, identified, and stored in memory on personal electronic device, ready for downloading and use with the integration system 100. The clinician or system operator can “dock” the personal electronic device in a docking station associated with the integration system 100, or wirelessly “dock” it via Bluetooth connection or any wireless communication connection. In this manner, the system can be adapted to receive operational data from a personal electronic device. Any one of plural preset configurations can then be selected during operation of the integration system 100 and provide for rapid reconfiguration of the integration system. A selected preset configuration can substantially immediately change the operating parameters of the integration system 100 in accord with data provided from the personal electronic device corresponding to the selected preset configuration. A clinician or system operator can scroll through various preset configurations, at will, to change operational aspects of the integration system 100 as needed. In some embodiments, a personal electronic device can be interfaced with the inventive system 100 to provide an active and removable touch-panel display, which provides user preferred system configurations. In some embodiments, a personal electronic device is suitably adapted with software applications operating therein to provide a “universal” remote controller for the integration system 100, e.g., for controlling the functions of the actual clinical equipment that is generating original clinical data such as digital data, images, audio recordings, etc.

In various embodiments, software and/or firmware executing on the central processing unit 210 includes one or plural self-diagnostic routines. A self-diagnostic routine can monitor the status of all electronic equipment while in use, and display one or plural status indicators on a control monitor or on a main display 120. The one or plural status indicators can be associated with each instrument in communication with the integration system, a group of instruments, software in operation on the system, or the entire system. In some embodiments, the self-diagnostic routines monitor the operational status of equipment, e.g., power status, internal processor status, communication status, etc. In some embodiments, the self-diagnostic routines monitor the status of data recorded by equipment, e.g., heart rate status, blood pressure status, respiration rate status, blood oxygenation status, etc. The self-diagnostic routines can be executed periodically. In various embodiments, any monitored status detecting a fault can trigger a cautionary or warning signal when the monitored status goes into a cautionary state, e.g., low power, loss of communication, low heart rate, low blood oxygenation. The cautionary or warning signal can be presented on audio, video, or a combination thereof, and designed to draw the attention of one or more attending team members. In some embodiments, various cautionary or warning signals are delivered only to certain designated team members, so as to reduce unnecessary distractions to other team members. In some embodiments, the warning signal comprises a temporary alteration of video images on the main display 120, e.g., one image can be enlarged to cover a larger portion of the display while other images reduced, or an image can be overlayed temporarily on top of other images, with or without transparency, or an image or portion of an image can be highlighted or emphasized, or large text can be overlayed on at least a portion of the display 120. In some embodiments, displayed images on the main video display 120 are rearranged as a result of detection of a fault.

In some embodiments, the software and/or firmware executing on the inventive integration system 100 routinely runs maintenance self-diagnostic tests while the operating room is not in use. The maintenance tests can include evaluating the operational status of each medical instrument in communication with the integration system 100, evaluating communication links 115, 140, 108 used by the system, and evaluating the operational status of each system component, e.g., internal boards, peripheral controls, video display, etc. In some embodiments, the maintenance self-diagnostic tests can detect or initiate instrument failure while the operating room is not in use, and provide a maintenance notification so that the system can be repaired by qualified personnel prior to its next scheduled use.

In certain embodiments, the software executing on the inventive integration system 100 includes an imaging display back-up procedure. For example, should the main high-resolution display 120 fail during use, an imaging back-up procedure can sense the display failure, and automatically reroute all displayed data to an auxiliary back-up monitor, or to a set of auxiliary back-up monitors.

In some embodiments, the inventive system 100 supports “mission critical” operation. In mission critical operation, failsafe computer routines provide substantially immediate replacement and continuation of displayed data should any equipment or software component of the system 100, which is identified as critical to the successful completion of an entire procedure, fail for a period of time between about 0.1 second and about 2 seconds, between about 0.1 second and about 1 second, and yet between about 0.1 second about 0.5 second in certain embodiments. The critical equipment and software components can be identified as such to software in operation on the system 100 by a system operator prior to the initiation of a procedure. In certain embodiments, critical equipment and software components are identified and retained in system software settings associated with particular procedures. The settings can be retained in or included with preset configurations. During a procedure, equipment redundancy and mirroring of data can be utilized to provide substantially immediate replacement and continuation of displayed data should any critical equipment or software component fail for a period of time. In certain embodiments, the system provides firewalls that have real time mirror imaging of data transfers and/or collections. Software toggles and data switches can provide for activation of redundant equipment in the event of primary equipment failure, and routing of data from the redundant equipment to the main display 120. In some embodiments, self-diagnostic routines in execution on the system 100 monitor the status of all system components and determine whether critical equipment and software components are operating properly or in failure mode. When failure mode is detected by the self-diagnostic routine, back-up procedures can be initiated.

In various embodiments, software in operation on the system 100 provides video enhancement algorithms. For example, a video enhancement algorithm can allow a system operator to dim certain parts of the video display and brighten a region of interest. The software can provide for alterations of color, contrast, brightness, saturation, hue, edge resolution, and the like, to enhance a visual display. In various embodiments, the software provides downstream video enhancement of source video images.

### VIII. Wireless Communication

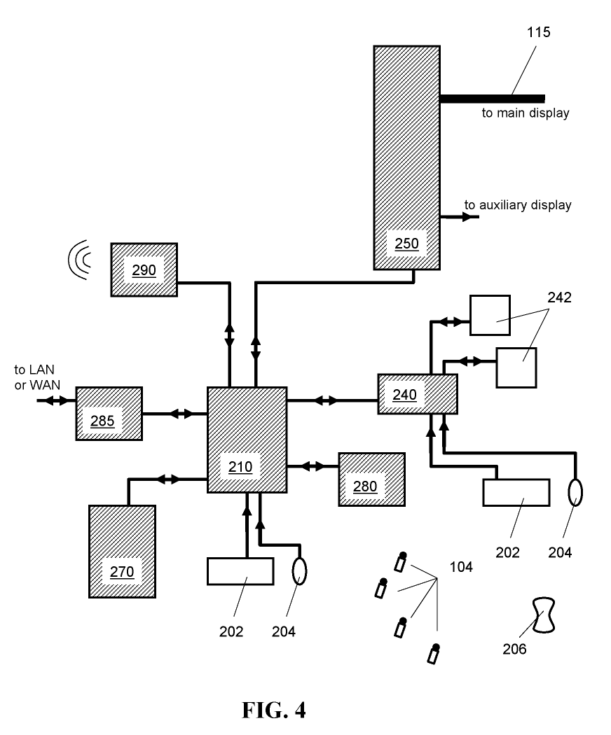

Referring now to FIG. 4, one embodiment of the inventive integration system 100 includes wireless communication between one or plural medical instruments and a wireless modem or communication board 290. In various embodiments, the wireless communication comprises an RF communication link. In certain embodiments, all data from one or plural medical instruments is communicated over the wireless link, and sent to the video processing engine 250. In some embodiments, some data from one or plural medical instruments is communicated over the wireless link, and video data is sent directly from each medical instrument via a wired link to the video processing engine 250. In some embodiments, some or all data from one or plural medical instruments is received over a local area network (LAN) or wide area network (WAN) via an internet communication modem or board 285. In some embodiments, communication between the inventive integration system 100 and one or plural medical instruments is established via a universal serial bus (USB) link. It will be appreciated that communication between the integration system 100 and medical instruments can comprise any one or a combination of communication methods, e.g., wired links, wireless links, LAN or WAN links, USB, HPIB, GPIB, RS-232, RS-485, IEEE 1394, IEEE 802, etc. In various embodiments, control of one or plural medical instruments in communication with the integration system 100 is asserted over a communication link, e.g., an applet passed over a LAN or WAN link, or instructions passed over a wired, wireless link, or USB link. In various embodiments, the integration system 100 provides a variety of communication ports or jacks for the addition of different types of peripheral equipment to the system 100, e.g., printers, chart recorders, video cameras, remote hard drives, remote memory, audio equipment, etc.

In certain embodiments, data from any remote-control apparatus is transmitted wirelessly and received by the wireless modem or communication board 290. Remote-control data received wirelessly can include gesture-based or motion-based control data, voice-recognition control data, image data, etc.

In certain embodiments, the integration system 100 provides for native control of one or plural of the medical instruments in communication with the system 100. For example, a medical instrument can be controlled by input from a system control console 102 or from the instrument's native controls 150, so that a team member can input data directly at an instrument. In some embodiments, the instrument's native controls 150 can be locked out or disabled for a period of time, so that control of the instrument can only be accepted through the integration system 100. In some embodiments, one or plural selected instruments' native controls can be disabled and other instruments' native controls allowed to accept input commands. In some embodiments, control of a selected group of instruments is enabled at one control console and can be locked out of all other control consoles as well as native controls for the selected instruments.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

The section headings used herein are for organizational purposes only and are not to be construed as limiting the subject matter described in any way.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. For example, the present teachings are directed primarily to medical applications, such as complex surgical procedures. However, it will be appreciated that the inventive integration system can be useful for non-medical applications, e.g., investment and market monitoring, manufacturing and process plant monitoring, surveillance (e.g., at casinos), navigating a ship/airplane/space shuttle/train, and the like.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. An integration system for medical instruments comprising:
a central processing station;
a high-resolution video display in communication with the central processing station, the communication established via an optical link;
a multi-way, high-fidelity audio communication subsystem providing for audio communication among members using the integration system;
a memory device in communication with the central processing station, and
at least one control console in communication with the central processing station, wherein the central processing station is adapted to receive plural types of data from plural medical instruments and to receive audio data from the audio communication subsystem, and the central processing station is adapted to provide coordinated control of the plural medical instruments through at least one control console.

2. The system of claim 1 further adapted for voice-recognition control.

3. The system of claim 1, wherein the central processing station is further adapted to record the plural types of data and audio data as a synchronized and indexed data stream.

4. The system of claim 3, wherein voice commands are used to index the recorded synchronized data stream.

5. The system of claim 1, wherein data passed over the optical link is substantially unaffected by magnetic fields having field strengths between about 0.5 Tesla and about 7 Tesla.

6. The system of claim 1, wherein the central processing station displays simultaneously images representative of a selected group of the plural types of data on the high-resolution video display.

7. The system of claim 6, wherein the selected group is determined by a preset display configuration.

8. The system of claim 6, wherein the selected group is alterable by input from the control console or voice command signals provided from the audio communication subsystem.

9. The system of claim 6, wherein the displayed data is right-sized so as to substantially eliminate image voids in the video display.

10. The system of claim 1 further adapted for gesture-based control.

11. The system of claim 10, wherein gesture-based control is derived from gloves worn by a system user.

12. The system of claim 10, wherein gesture-based control is derived from a wristband worn by a system user.

13. The system of claim 10, wherein gesture-based control is derived from facial expressions of a system user.

14. The system of claim 10, wherein gesture-based control is derived from a handheld remote-control device operated by a system user.

15. The system of claim 1, wherein the control console comprises a graphical user interface displayed on all or a portion of the video display.

16. The system of claim 15, wherein the graphical user interface is displayed temporarily during operation of the system.

17. The system of claim 1 further adapted for electronic chalkboard operation.

18. The system of claim 1 further adapted for multi-way electronic chalkboard operation.

19. The system of claim 1, wherein the video display comprises a 56-inch, 8 megapixel display.

20. The system of claim 1, wherein the video display is coated with an antibacterial coating.

21. The system of claim 1, wherein the video display comprises a holographic projection system for projecting a three-dimensional image.

22. The system of claim 1, wherein the central processing station comprises:
a computer;
at least one keyboard-video-mouse switch; and
a video processing engine.

23. The system of claim 1, further adapted to periodically execute self-diagnostic routines to monitor the status of the integration system and plural medical instruments in communication with the integration system.

24. The system of claim 23, wherein detection of a fault status causes temporary enlargement, rearrangement, or highlighting of one or more images displayed on the video display.

25. The system of claim 23, wherein substantially immediate replacement and continuation of displayed data is provided when an instrument or software component of the integration system identified as critical fails for a period of time between about 0.1 second and about 2 seconds.

26. The system of claim 1, wherein the audio subsystem provides for the addition of background music.

27. The system of claim 1 further adapted to provide pre- and post-intervention comparison of one or more of plural types of data.

28. The system of claim 1 further adapted to receive operational data from a personal electronic device.

29. The system of claim 1, wherein the audio subsystem comprises a wireless communication system.

30. The system of claim 1, wherein the plural medical instruments are in wireless communication with the integration system.

31. The system of claim 1, wherein control of a selected group of the medical instruments is locked out of all but one control console.

32. The system of claim 1, wherein one control console is located in an operating room and one control console is located in a remote control room.

33. The system of claim 1 adapted for use in a facility selected from the following group: an operating room, an electrophysiology laboratory, a catheter laboratory, an image guided therapy facility, a neurosurgery facility, a radiology facility, a cardiac catheterization facility, a patient room, a bay or isolette within an emergency medicine facility, a trauma facility, an intensive care facility, a critical care facility, a neo-natal intensive care facility, an OB/GYN facility, a labor facility, and a delivery facility.
